(19) United States
(12) Patent Application Publication
(10) Pub. No.: US 2012/0137548 A1
(43) Pub. Date: Jun. 7, 2012

(54) HAND TOOL STAND

(76) Inventor: Kim S. Kimball, Murray, UT (US)

(21) Appl. No.: 13/310,352

(22) Filed: Dec. 2, 2011

Related U.S. Application Data
(60) Provisional application No. 61/458,950, filed on Dec. 6, 2010.

(51) Int. Cl. B25G 1/00; A01B 39/08; A01D 7/00; E01H 5/02; A01B 1/00; A01B 1/20

(52) U.S. Cl. 37/266; 16/110.1; 172/371; 172/349; 56/400.14

(57) ABSTRACT

A hand tool (or an add-on accessory for the hand tool) with a handle includes one or more retractable arms that, when unfolded and extended maintains the tool in an upright position while the tool is at rest; and an attachment coupling the one or more retractable arms to the handle, the one or more arms rotatably engaged to attachment and the handle and when unfolded the one or more arm maintains the handle in an upright position off the ground to make the tool visible to an operator, wherein the one or more arms are retracted and secured into a closed position against the handle when the operator desires to resume work.

This application claims priority to Provisional Application 61/458,950 filed Dec. 6, 2010 and 13/281,423 filed Oct. 25, 2011, the contents of which are incorporated by reference.

### BACKGROUND OF THE INVENTION

The present invention relates generally to a stand to be used on the handles of hand tools; more specifically it relates to a retractable stand device that can be attached to the handles of garden, construction, landscaping, maintenance, and household hand tools that holds the handle in an upright position for safety and ease of use in a working environment.

### DESCRIPTION OF RELATED ART

Various types of stands are used to hold or prop up various types of items for greater convenience of use. They come in many shapes and sizes with specific uses and purposes as needed to assist in the use of a specific item. For example, stands are commonly used to prop up items like signs, bicycles, telescopes, artwork, cameras, equipment, displays etc. Most stands are used to keep items stable and in an easily accessible position so when the user decides to use the item, it is quickly available.

Stands such as a tripod used on an artist's easel, a camera or telescope are used to stabilize the device while using them. The three legs provide the stability required to maintain the device in a more or less upright disposition. Three points of contact to the ground are the minimum required for stability.

With a bicycle, the use of a kickstand is designed specifically to_keep the bicycle in an upright standing when the bicycle is not in use. Kickstands are commonly “kicked” down and out by a rider's foot, where it locks in place.

In the use of handled tools such as rakes, hoes, and the like, when the tool is not in use, it is either set down on the ground, or as convenient, it is positioned up against a wall, fence, or some other vertical surface in order to prop it up. It goes without saying that leaving a handled tool on the ground when not in use especially in a work environment, creates a dangerous environment where people can trip over the tool, step on its tines, and cause injury. These hand tools lying on the ground may also be broken or damaged by the people that step on them or with the subsequent use of other equipment. It is not uncommon for a tool to be left on the ground and accidentally run over by a lawn mower, tractor, or car.

In a work environment tools left on the ground creates a particularly dangerous environment due to the number of workers in the area. A hand tool left on the ground is a common hazard to workers who may not see them. Likewise a hand tool left on the ground at the worksite often results accidently leaving the tool behind at the completion of a day's work only to find it missing the next day. Replacement is expense especially considering the loss of time of replacement.

In normal use, the operator of a hand tool will put the tool to the ground while temporarily changing tasks, then pick it back up again. This inconvenience may be repeated several times during the day. In a work environment, it magnifies the problems of potential injury to others, or damage, as well as the stress on the user's body. Continually picking up and putting down hand tools not only creates undo stress to the body, it slows down work. This is particularly true if the user elects to avoid the danger of leaving a tool on the ground and looks for a place to prop it up, for example a nearby wall. With elderly or handicapped people bending down to pick up a tool may not be an option due to pain or discomfort to the body. It may even cause serious back injury.

As an alternative to lying a hand tool on the ground, the worker may try to find a nearby location to lean the hand tool against in an upright disposition. The problem with leaning a hand tool against an object in a work environment is that the object used, may need to be used for another purpose, thus the hand tool is set in yet another location (unbeknownst to the worker) or left lying on the ground.

At times hand tool in use, such as a mop, may be propped up against a nearby counter, although this tends to be unstable. If is slides off sideways, it can create spillage of soapy water, or any other substance that is being used or cleaned up such as chemicals, tar etc. creating a possible dangerous or damaging condition. The threat of being hit with a falling unstable hand tool in the work area is also of concern.

It is understandable that without some form or means of maintaining a handled stand in a visible, obvious, upright, disposition, the problems with prior art will persist. The existing stands used for various devices are created with specific application and with specific purposes for those devices and are inadequate for use with hand tools.

A hand tool stand device overcomes the numerous problems associated with prior art would be valuable to the trades of gardening, construction, landscaping, maintenance, and household and others.

### BRIEF SUMMARY OF THE INVENTION

In one aspect, a tool consists of an attachable means that is secure to the handle of a hand tool in which a retractable arm or arms as the case may be are secured. The retractable arm, when unfolded and extended maintains the tool in an upright position while the tool is at rest. The arm or arms may rotate up or down manually as needed from its attachment to the handle. When unfolded downward the arm maintains the handle of the tool in an upright position and off the ground. This makes the tool visibly accessible to the operator, and visible to those in the work area. The tool stand device of the present invention can quickly be retracted manually and secured into the closed position against the handle when the operator desires to resume work.

In another aspect, a hand tool (or an add-on accessory for the hand tool) with a handle includes one or more retractable arms that, when unfolded and extended maintains the tool in an upright position while the tool is at rest; and an attachment coupling the one or more retractable arms to the handle, the one or more arms rotatably engaged to attachment and the handle and when unfolded the one or more arm maintains the handle in an upright position off the ground to make the tool visible to an operator, wherein the one or more arms are retracted and secured into a closed position against the handle when the operator desires to resume work.

Implementations of the above aspect can include the following. The tool can be made with the device “built into” the handle, making the device and the handle one complete unit that is flush with the handle. In other words the retractable arm is attached directly to the handle itself. It may also form-fit the handle without being obtrusive. When the present invention is installed, and the arm or arms of the stand are deployed from the handle downward resting atop the ground surface, the tool head and tool handle combined with the stand creates two or more contact points that provide stability to the tool in an upright position. The reason that only two points of contact may provide stability is that at least one of the two is broad enough across its base to form at least a three-point disposition, similar to that of a tripod. For example the tool head on a rake spreads two to three feet across, and with a second point being the retractable arm, there is a tripodal effect. This tripodal effect consists of the two outer ends of the rake and the single retractable arm of the present invention.

Another embodiment of the hand tool stand device is that the arms of the device may have a telescoping feature, so if needed, the operator may determine the upright angle of the handle.

Advantages of the preferred embodiments may include one or more of the following:

1) Provide a stabilizer for maintain a hand tool in an upright disposition;
2) Create a safer work environment by reducing tripping over tools;
3) Eliminate the need for leaning unstable tools against or onto objects;
4) Eliminate the problem of tools sliding off, slipping or falling when placed against an object;
5) Make hand tools convenient to use;
6) Reduce loss of hand tools by making hand tools more viable;
7) Reduce breakage or damage of hand tools by keeping them off the ground;
8) Make a standalone unit easy to install on existing tool handles;
9) Make the hand tool stand device an inexpensive attachment;
10) Make the handles with the hand tool stand device part of a complete unit that is retractable into the handle.
11) Provide a hand tool stand-up device with one or more stabilizing arms or in some cases a wider base unit on the stand itself.

Other advantages of the preferred embodiments may include one or more of the following. The stand for handled tools of the present invention overcomes the problems associated with prior art. The present invention is a device that is designed specifically for the use with hand tools to enhance the stability, workability, safety and functionality of garden, maintenance, landscape, construction and household tools. The present invention is adaptable to most hand tools that are able to create a tripodal effect. In other words it has the same type of stabilizing properties as that of a tripod.

By employing the tool, the need to bend down and pick up the hand tool is eliminated, thus creating better accessibility to the tool later on when needed. In addition there is no need to lean the tool against other objects which eliminates the risk of the tool falling or causing damage if it slides away. The hand tool stand device is a complete unit and attachable to any hand tool handle and may be installed easily to existing hand tools. It may also be standard equipment with replacement handles, with the hand tool stand device already attached.

Furthermore, it is an object of this application to illustrate the preferred embodiments and broadly state the methodologies that may be used in order to maintain a hand tool in an upright disposition.

### BRIEF DESCRIPTION OF THE DRAWINGS

FIG. 1 is a perspective view of representation illustrating components that make up various preferred embodiments and their related elements.

FIG. 2 is a perspective view of one embodiment of the present invention illustrating it in a closed disposition.

FIG. 3 is a perspective view of another embodiment of the present invention.

FIG. 4 is a perspective view of another embodiment of the present invention with two shafts forming a tripod effect.

FIG. 5 is a perspective view of yet another variation of the present invention.

### DETAILED DESCRIPTION OF THE INVENTION

### A. Description of the Present Invention

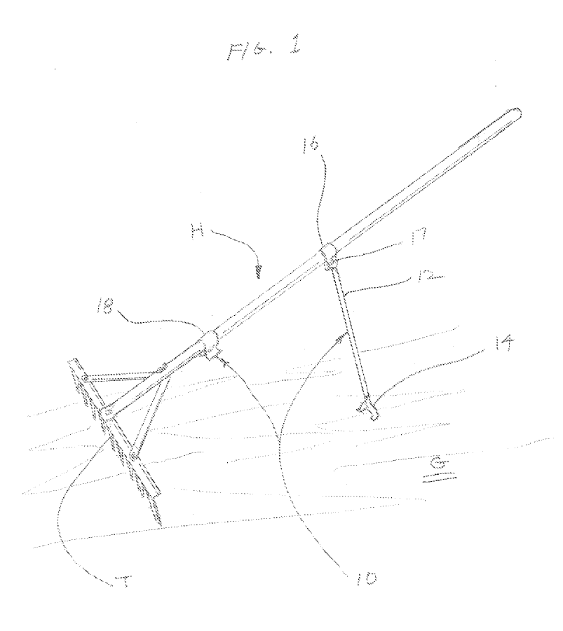

In FIG. 1 the present invention 10 consists of hand tool H (in this instance a rake), with a handle 20 and a tool head 30. The present invention, hand tool stand 10 consists of a standup shaft 12, a foot 14, a keyhole shaped adapter 16, pivot pin 17, and a socket holder 18. Keyhole adapter 16 has a U-shape similar to that of shower ring or a common plumbing pipe hanger. As shown, keyhole adapter 16 wraps around handle 29 and secures the upper end of shaft 12 onto adapter 16 by having pivot pin 17 threaded through shaft 12.

As illustrated, hand tool stand 10 is in an upright disposition off of ground G, with standup shaft 12 extended downward with foot 14 resting firmly on ground G, thus supporting hand tool H. As illustrated, handle 20 extends outward and upward into the air, above ground surface G. In this upright disposition, hand tool H is clearly off the ground and visible to other persons or workers in the area, thus eliminating the potential dangers of a hand tool that is lying on the ground.

As illustrated in FIG. 1 there are two surfaces that touch the ground. The first being the tool head T and the second being foot 14 of the present invention 10. As can be easily understood, this combination presents a tripodal effect due to the broad width of tool head T. The positioning of hand tool stand 10 is important and cannot be too near the top end of handle 20 as would then tend to lose the tripodal effect and may become somewhat unstable. Likewise if it is connected to low down on handle 20 near tool head T, then it may be somewhat top heavy. The use of the present invention is not limited to only rakes, but may be used on any number of hand tools such as hoes, brooms, screeds, and so on.

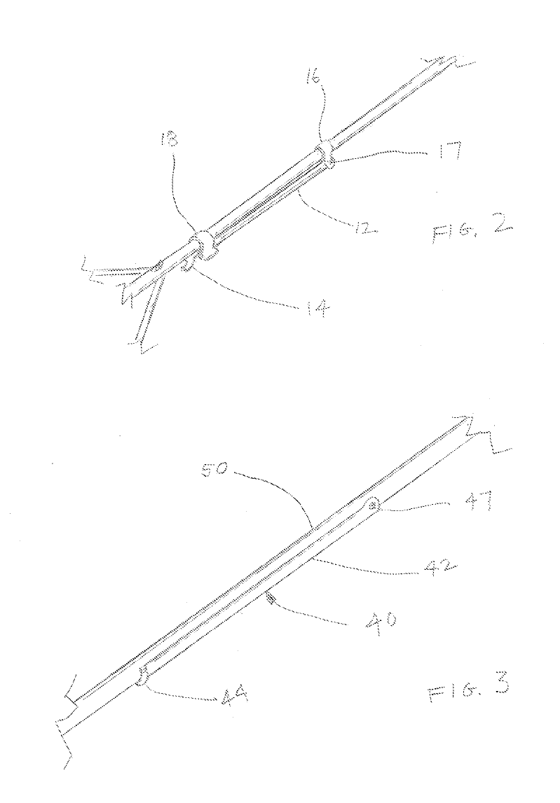

In FIG. 2 the retractable standup shaft 12 is illustrated in a folded-up disposition with standup shaft 12 locked into and secured by socket holder 18. The retractability is made possible with the upper end of shaft 12 pivotally pinned in place by pivot pin 17 that connects through both sides of keyhole shaped adapter 16 with shaft 12 in between. In this folded up disposition, hand tool H is ready to be put in use. The retractable tool stand 10 as illustrated in FIG. 2 facilitates easy opening, and the flipping down of hand stand 10 as illustrated in FIG. 1.

The present invention illustrated in FIGS. 1 and 2 may be made in various configurations similar to those illustrated. For example, the adapter 16 may have its pivot pin 17 on the bottom side or the top side of handle 20, or may even have pivot pin 17 running through handle 20 in median location. Tool stand shaft 12 may also be connected directly to handle 20 without adapter 16, but solely with a pivot pin that is connected directly through handle 20. The tool stand shaft 12 may be made in any number of configurations, tubular, solid or otherwise, with the provision that it can be pivotally attached to handle 20. Likewise foot 14 may be in any number of configurations that suitably allow it to stand upright or, there may be no foot at all. All of the components that make up hand tool stand 10 may be made from steel, aluminum, plastic, even wood.

### E. Variations

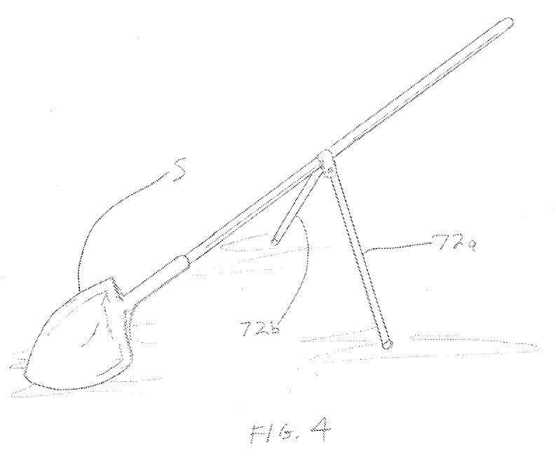

In FIG. 3 the present invention, hand tool stand 40, is shown as one single piece attached to handle 50, which handle may be that of a rake, hoe, broom, and so on. In this variation, shaft 42 is a half-round piece of metal that conforms to the round handle 50 and is attached to handle 50 through pivot pin 47. As illustrated there is no adapter, just the single pivot pin 47 that affixes shaft 42 to handle 50. In this variation there is also a simple foot 44, which may be a rubber, vinyl, or metal boot, or there may be none at all. It will still function admirably without. This configuration is more adaptable to an OEM manufacturer instead of attaching later on and performs essentially the same as the invention in FIGS. 1 and 2.

The style disclosed in FIG. 3 may be effectively manufacturers with a spring clip (not shown) attached to pivot pin 47 and mounted beneath the underlying shaft 42. The spring clip allows the present invention to hold securely against handle 50 when in a closed disposition, and when hand tool stand 40 is pulled open against the resistance of the spring clip, it snaps open into position perpendicular to handle 50 and thus, the hand tool stands up. This type of action with the spring clip is similar to that of a windshield wiper on an automobile.

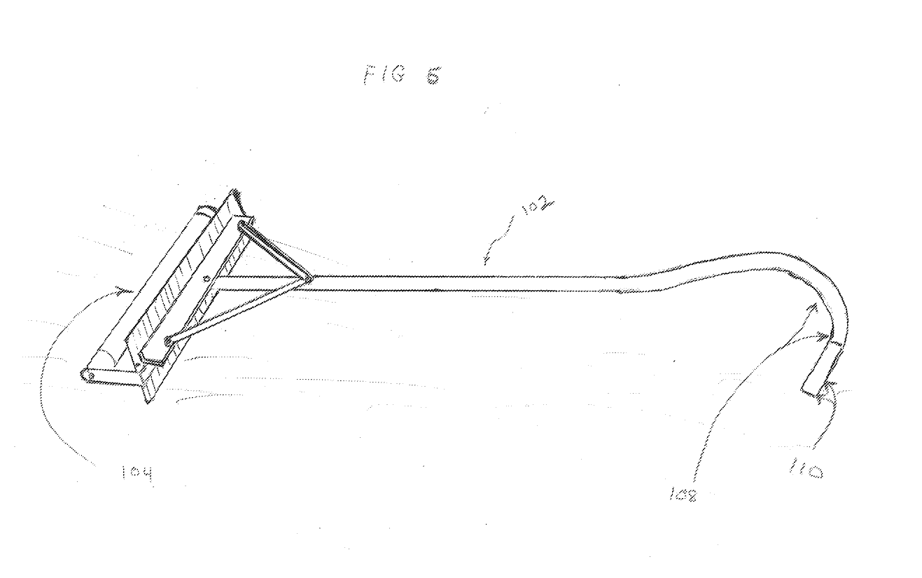

FIG. 4 is one other variation of the present invention, which shows hand tool stand 70 with two shafts 72a and 72b. This variation is more suitable for hand tools that do not have tool heads with much breadth, such as the shovel illustrated. While a single shaft such as shafts 12 and 42 as illustrated in FIGS. 1, 2, and 3, forms a tripodal effect with a broad tool head, the variation in FIG. 4 creates a true tripod, with the too shafts 72a and 72b touching the ground and spaced apart from one another and tool head S being the third leg in the tripod. The retracting of the two arms may be much like that of the previously disclosed inventions, except that the two are spaced apart.

FIG. 5 shows another embodiment of the invention. In FIG. 5, a hand tool includes a handle pole 102 that has a stand portion 108 that curves downwardly from the hand tool handle pole 102. The stand portion 108 terminates in a handle grip 110 that guards a contact point on the ground. The other end of the hand pole 102 is connected to a tool head 104. The tool head offers several substantial advantages. First, it maintains an even drawing when the user (not shown) pulls on the hand tool. In other words, one side will not dip down or rise up further than the other. Second, the ease of pulling on the hand tool is lessened preventing tiring by the user, which is particularly important when raking or dozing larger surfaces. Third, the handle gives the user the unprecedented ability to push and pull the rake, thus greatly speeding up the intended process. Fourth, with the tool the user may easily feather surfaces, which is highly desirable in many applications. Fifth, the handle can be pushed against comfortably by the body when needed to give additional weight and power to the tool head to move snow, dirt or other materials when necessary. For example, dirt and gravel walkway, school grounds, a baseball infield, grass surfaces where it may be desired to remove pick up leaves and pine cones without interrupting or snagging the underlying grass. The device of FIG. 5 serves not only serves as a stabilizer or a leverage device during use, it also provides a grading function that smoothes down surface after the raking when using the pulling process.

As illustrated, the present invention may be made in a multitude of configurations and styles. Other variations may include telescoping shafts so the user may adjust the angle and height to which the hand tool stands up. It may even include more than two shafts if a broader stance is preferred. Regardless of the means of attachment to the handle or the method in opening the hand tool stand, the result is essentially the same.

The spirit of the present invention provides a breadth of scope that includes all methods of making and using it. Any variation on the theme and methodology of accomplishing the same that are not described herein would be considered under the scope of the present invention.

What is claimed is:

1. A hand tool, comprising:
a tool head; and
a handle having:
one or more retractable arms that, when unfolded and extended maintains the tool in an upright position while the tool is at rest; and
an attachment coupling the one or more retractable arms to the handle, the one or more arms rotatably engaged to attachment and the handle and when unfolded the one or more arm maintains the handle in an upright position off the ground to make the tool visible to an operator, wherein the one or more arms are retracted and secured into a closed position against the handle when the operator desires to resume work.

2. The tool of claim 1, wherein the one or more arms extend from the handle downward to rest atop the ground surface, the tool head and tool handle combined with the stand creating two or more contact points that provide stability to the tool in an upright position.

3. The tool of claim 1, wherein the tool head spreads approximately two to three feet across, and with a second point being the retractable arm to form a tripod.

4. The tool of claim 1, wherein the arms of the device may have a telescoping feature to determine the upright angle of the handle.

5. The tool of claim 1, wherein the arms form a stabilizer for maintain a hand tool in an upright disposition.

6. The tool of claim 1, wherein the arms are retractable into the handle.

7. The tool of claim 1, comprising a stabilizer bar with first and second outboard extensions.

8. The tool of claim 7, wherein the handle is secured to the stabilizer bar, wherein the stabilizer bar provides a stabilizing contact point to the working surface that in turn is a fulcrum of a leverage point providing side to side stability.

9. The tool of claim 1, wherein the stabilizer bar comprises a roller.

10. The tool of claim 9, wherein the roller comprises a leverage device during raking and a grader that smoothes ground surface after raking when using a pulling process.

11. An add-on accessory for a hand tool with a handle, comprising:
one or more retractable arms that, when unfolded and extended maintains the tool in an upright position while the tool is at rest; and
an attachment coupling the one or more retractable arms to the handle, the one or more arms rotatably engaged to attachment and the handle and when unfolded the one or more arm maintains the handle in an upright position off the ground to make the tool visible to an operator, wherein the one or more arms are retracted and secured into a closed position against the handle when the operator desires to resume work.

12. The accessory of claim 11, wherein the one or more arms extend from the handle downward to rest atop the ground surface, the tool head and tool handle combined with the stand creating two or more contact points that provide stability to the tool in an upright position.

13. The accessory of claim 11, wherein the tool head spreads approximately two to three feet across, and with a second point being the retractable arm to form a tripod.

14. The accessory of claim 11, wherein the arms of the device may have a telescoping feature to determine the upright angle of the handle.

15. The accessory of claim 11, wherein the arms form a stabilizer for maintain a hand tool in an upright disposition.

16. The accessory of claim 11, wherein the arms are retractable into the handle.

17. The accessory of claim 11, comprising a stabilizer bar with first and second outboard extensions.

18. The accessory of claim 17, wherein the handle is secured to the stabilizer bar, wherein the stabilizer bar provides a stabilizing contact point to the working surface that in turn is a fulcrum of a leverage point providing side to side stability.

19. The accessory of claim 11, wherein the stabilizer bar comprises a roller.

20. The accessory of claim 19, wherein the roller comprises a leverage device during snow or debris removal, raking and a grader that smoothes ground surface after raking when using a pulling process.
